(19) United States
(12) Patent Application Publication
(10) Pub. No.: US 2009/0086272 A1
(43) Pub. Date: Apr. 2, 2009

(54) Systems and methods for loading an output profile

(76) Inventors: Michael Januszewski, Lafayette, CO (US); Douglas Obrecht, Longmont, CO (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/904,757

(22) Filed: Sep. 27, 2007

(51) Int. Cl. G06K 15/00

(52) U.S. Cl. 358/1.17

(57) ABSTRACT

Systems in accordance with the presently claimed invention use parameters to choose the correct output file for translating the color values in a print job into device specific values in an output data file that may be used for printing. A data structure, such as a linked list of parameters, may be used to identify the correct output file to be used by the printer to form the correct device specific data file. The color values for each pixel in the device specific data file may allow a printed document to exhibit high color quality.

### BACKGROUND

1. Field of Invention

This disclosure relates to assigning color values to the pixels of an output print job and more particularly, to quickly determining the appropriate output profile for the print job.

2. Description of Related Art

When a user requests a print out of a document from a computer terminal, the document may be sent to the printer in a page description language file. This page description language file may provide a list of attributes of the document to be printed. These attributes may include the color attributes of the document in an industry standard set of colors, such as red, blue, and green, the media to use for the printed document, and the halftone and resolution depth of the printed document. When the printer receives the page description language file, it may translate the attributes in the page description language file into data that the printer can use to produce the output file.

In some printers, an output file may be used to provide this translation. Output files correlate device-independent color values with device specific color values that represent the actual color users see on a printed page. In some printers, information in the output file may be hard-coded into the firmware of the printer, but hard-coding this information into the firmware complicates the task of updating the values in the output file. In some printers, the output file may be kept in a more accessible memory location to allow the values in the output file to be updated. But loading this information from the more accessible memory into the printer's firmware used to complete a print job may be a time-consuming process.

Accordingly, there is a need for a system and method for quickly determining and loading an output file into a printer.

### SUMMARY

In accordance with described embodiments, apparatuses, systems, and methods for generating improved print quality of multibit image data on a bitonal print apparatus are shown.

In some embodiment, an image forming apparatus may comprise a first memory component located in a printing device, the first memory component receiving one or more data files and a print job file from one or more external memory devices, a DMA control module, the DMA control module parsing the one or more input files to create a decision data structure; a color management system stored in the first memory component, wherein a CPU accesses the color management system to identify one of a plurality of output files based on information in the print job file using the decision data structure and translate the print job file into a printer specific data file based on information contained in one of the plurality of output files. The image forming apparatus may also comprise one or more print heads operable to print an output document as a function of the printer specific data file.

In some embodiments, the decision data structure comprises a linked list. The decision data structure may include a set of parameters for identifying the one of the plurality of output files. The set of parameters may consist of a color model, a type of media, a halftone setting, and a resolution depth setting.

In some embodiments, the plurality of output files may be stored in a second memory component, the color management system being operable to load the plurality of output files into the first memory component when the printing device is booted up. The second memory component may be stored the plurality of output files in one or more XML format files.

In some embodiments, a method for forming an image may comprise receiving at a first memory component in a printing device one or more data files and a print job file from one or more external memory device, parsing the one or more input files at a DMA control module to create a decision data structure, and accessing a color management system stored in the first memory component, wherein the color management system identifies one of a plurality of output files based on information in the print job file using the decision data structure; and translates the print job file into a printer specific data file based on information contained in one of the plurality of output files; and transmits the printer specific data file to one or more print heads that are operable to print an output document as a function of the printer specific data file.

### BRIEF DESCRIPTION OF THE DRAWINGS

FIG. 1 shows a block diagram of an exemplary printer coupled to an exemplary computer.

FIG. 2 shows an exemplary process for translating the device independent file received by the printer.

FIG. 3, shows an exemplary linked list that may result from parsing the output files.

### DETAILED DESCRIPTION

Reference will now be made in detail to one or more exemplary embodiments as illustrated in the accompanying drawings. Wherever possible, the same reference numbers will be used throughout the drawings to refer to the same or like parts.

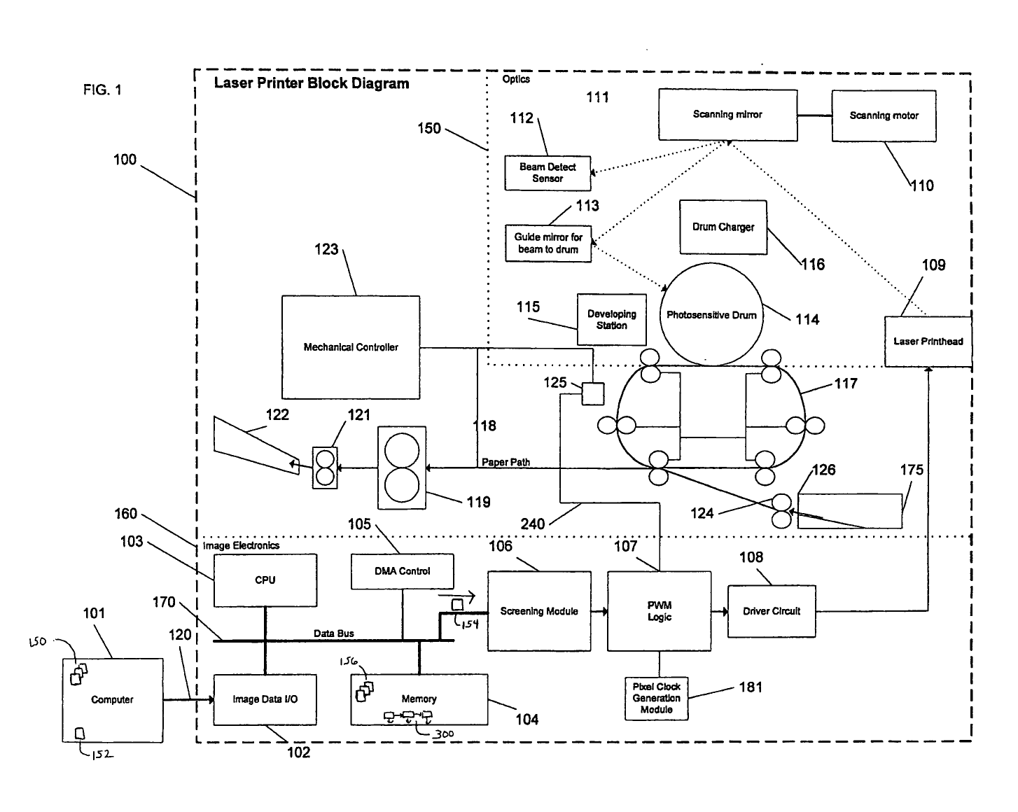

FIG. 1 is a block diagram of exemplary printer 100, which is coupled to exemplary computer 101. In some embodiments, printer 100 may be a laser printer, an LED printer, or any other printer consistent with principles of the present invention. Computer 101 may be a computer workstation, desktop computer, laptop computer, or any other computing device capable of being used with printer 100. Connection 120 couples computer 101 and printer 100 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as USB, FIREWIRE and/or serial or parallel ports for transmission of data through appropriate connection 120. The communication links could be wireless links or wired links or any combination consistent with embodiments of the present invention that allows communication between computing device 101, and printer 100.

In some embodiments, data received by printer 100 may be routed internally along internal data paths, such as exemplary data bus 170, and other data and control signal paths (not shown) to various internal functional modules of printer 100 as determined by control logic in printer 100. In some embodiments, data transmitted to printer 100 by computer 101 may also include destination addresses and/or commands to facilitate routing. In some embodiments, data bus 170 may include a subsystem that transfers data or power among modules. In some embodiments, data bus 170 may logically connect several modules over the same set of wires or over separate wires for each connection. In some embodiments, data bus 170 may be any physical arrangement that provides the same logical functionality as a parallel bus and may include both parallel and bit-serial connections. In some embodiments, data bus 170 may be wired in either an electrical parallel or daisy chain topology, or connected by switched hubs.

In some embodiments, image data input/output (“IO”) module 102, central processing unit (CPU) 103, direct memory access (DMA) control module 105, memory 104, and screening module 106, may be coupled using data bus 170. Data received by image data I/O module 102 may be placed in memory 104 using DMA control module 105 under the control of the CPU 103 according to some embodiments of the present invention. Screening module 106 may also be coupled to pulse width modulation (PWM) logic module 107. In some embodiments, screening module 106 may contain a decompressor sub-module that can receive compressed pixel data, decompress the received pixel data, and send it to PWM logic module 107. In some embodiments, a decompressor module may be separate from screening module 106.

Various data and control signal paths may couple PWM logic module 107, pixel clock generation module 181, driver circuit 108, printhead 109, mechanical controller 123, beam detect sensor 112 and transfer belt position sensor 125. In some embodiments, printhead 109 may be a laser printhead. In some embodiments, beam detect sensor 112 and/or belt position sensor 125 may each generate several signals for each scan line in an image, or for a set of scan lines in an image, or for each image and send the generated signals to mechanical controller 123, which then sends signals to PWM logic module 107.

Driver circuit 108 may be communicatively coupled to PWM logic module 107 and printhead 109. In some embodiments, scanning mirror 111 may be mechanically or electromagnetically coupled to scanning motor 110, which may be used to rotate scanning mirror 111. Light from printhead 109 may be transmitted to scanning mirror 111 and scanning mirror 111 may reflect that light, at different times, to beam detect sensor 112 and beam-to-drum guide mirror 113. Beam-to-drum guide mirror 113 may reflect light from scanning mirror 111 to photosensitive drum 114. Drum charger 116 may be used to charge photosensitive drum 114.

Paper 175 may be passed from paper input tray 126 through transfer rollers 124 to transfer belt 117 where latent images from photosensitive drum 114 may be transferred to paper 175. In some embodiments, latent images from photosensitive drum 114 may be developed with toner at developing station 115 before transfer to paper 175. The transfer of images from photosensitive drum 114 to paper 175 may occur while paper 175 is on transfer belt 117. After the image has been transferred, paper 175 may be moved over paper path 118 using transfer rollers 124 and past fuser 119, guide rollers 121, and to paper output tray 122. In some embodiments, fuser 119 may facilitate the bonding of the transferred image to paper 175.

Exemplary print engine 150 of printer 100 may include beam detect sensor 112, beam-to-drum guide mirror 113, developing station 115, photosensitive drum 114, drum charger 116, scanning mirror 111, scanning motor 110, and printhead 109. Exemplary image electronics subsystem 160 may include CPU 103, image data I/O module 102, memory 104, DMA control module 105, data bus 170, screening module 106, PWM logic module 107, and driver circuit 108. The various modules and subsystems described above may be implemented by hardware, software, or firmware or by various combinations thereof.

In some embodiments, computer 101 may send image data to image electronics subsystem 160 over connection 120. The image data sent from the computer 101 may be compressed. In some embodiments, the compressed image data may be in a line-sequential compressed format. Various other formats such as Postscript, PCL, and/or other public or proprietary page description languages may also be used to transfer image data. The image data may be stored in print job 152 on computer 101. In some embodiments, the image data sent by computer 101 may include device-independent color values for each pixel. These color values may be in an industry standard set of colors, such as red, blue, and green.

In some embodiments, the printer may translate the industry standard set of colors into device specific color values representing the actual color to be printed on the medium. One or both of image data I/O module 102 and DMA control module 105 may translate the device-independent color values into device-dependent color values. Image data I/O module 102 and/or DMA control module 105 may use output files 156 stored in memory 104 to translate the device independent files into a device specific file. These device-specific values may include the color model used by the printer, the media to be used for a printout, and the half-tone and pixel resolution depth to be used for the printout. CPU 103 may control image data I/O module 102 and/or DMA control module 105 during this translation process. The device specific values may be transmitted to screening module 106 in device specific file 154.

After device-independent color value image data is obtained by image data I/O module 102, the image data may be placed in memory 104 using DMA control module 105 under the control of CPU 103. In some embodiments, when device-independent color value image data for a complete page has been stored in memory 104, a print sequence may be initiated. In some embodiments, mechanical controller 123 may initiate operations of scanning motor 110, photosensitive drum 114, and transfer belt 117 through appropriate data and/or control signals.

Beam detect sensor 112 can detect a laser beam's position and generate pulses that are sent to image electronics subsystem 160 so that image data can be properly aligned from line to line in a printed image. In some embodiments, at the beginning of a scan of each line of the image, light from the printhead 109 may be reflected by scanning mirror 111 onto beam detect sensor 112. Beam detect sensor 112 may signal mechanical controller 123 which, in turn, may send a beam detect signal 240 to PWM logic module 107. In some embodiments, a separate signal typically referred to as top of data (TOD) or “vsync” may also be generated by mechanical controller 123, based on information received from transfer belt position sensor 125. The TOD or vsync signal indicates when image data transfer can begin for paper 175. For example, in some embodiments, a TOD signal may be sent to PWM logic module 107 via mechanical controller 123. Once the TOD signal is received, CPU 103 may initiate a transfer from memory 104 to decompressor module 106. In some embodiments, decompressor module 106 may decompress image data and pass the resulting raw image data to PWM logic module 107. The resultant PWM pulses from PWM logic module 107 may then be streamed to driver circuit 108, which may then transmit the PWM pulses to printhead 109.

In some embodiments, laser light from printhead 109 may be pulsed and reflected off scanning mirror 111 and beam-to-drum guide mirror 113, causing a latent image of charged and discharged areas to be built up on photosensitive drum 114. In some embodiments, toner develops this latent image at the developing station 115 and the latent image may be transferred to transfer belt 117. For a multi-component image, such as a color image, the latent image building process may repeat for each of the components. For example, for CMYK color printers, which use cyan (“C”), magenta (“M”), yellow (“Y”), and black (“K”), the latent image building process on photosensitive drum 114 may be repeated for each of the colors C, M, Y, and K. In some embodiments, when all components have been assembled on transfer belt 117, paper 175 may be fed from paper input tray 126 to transfer roller 124 where the image may be transferred to paper 175. In some embodiments, fuser 119 may then fix the toner to paper 175, which is sent to paper output tray 122 using guide rollers 121.

Pixel clock generation module 18.1 may be a crystal oscillator or a programmable clock oscillator, or any other appropriate clock generating device. In some embodiments, such as in a “multi-pass” printer 100, which sends the video data for each color serially in sequence, the frequency of the clock generated by the pixel clock generation module 181 may be fixed among each pass of the printer. In an example multi-pass printer 100, the pixel clock generation module 181 may be a crystal oscillator. In another embodiment, such as a printer 100 that uses multiple sets of print engines 150, sometimes collectively referred to as a “tandem engine”, the frequency of each channel may be calibrated if the frequencies differ among the pixel clocks corresponding to each of the color components. In such embodiments, one or more programmable clock oscillators may be used to allow for calibration.

Exemplary embodiments of printer 100 may include driver circuit 108 driving multiple sets of print engine 150, which may be connected to multiple printheads 109. In some embodiments, printheads 109 could all be laser printheads. There may also be a plurality of individual modules of image electronics subsystem 160. For example, a single screening module 106 may be connected to multiple PWM logic modules 107 with each PWM module 107 being connected to one or more pixel clock generation modules 181 and one or more driver circuits 108. Screening module 106 could provide each PWM logic module 107 with one or more color components of an image, which would then be sent to the multiple driver circuits 108 for onward transmission to one or more sets of print engine 150.

In other embodiments, multiple screening modules 106 may be coupled to multiple PWM logic modules 107. Each screening module 106 may provide a PWM logic module 107 with a decompressed component of the image. In other embodiments a single PWM logic module 107 could provide multiple components of the image to multiple driver circuits 108.

In some embodiments, printer 100 may have multiple lasers per laser printhead. In some embodiments, printhead 109 may receive multiple lines of data from driver circuit 108 and project the multiple lines of data to scanning mirror 111. Scanning mirror 111 may then reflect the multiple lines of data to beam detect sensor 112 and guide mirror 113, which may reflect the multiple lines to photosensitive drum 114. In some embodiments, the beam detect sensor 112 may detect a signal, such as a laser signal, reflected off of the scanning mirror 111, or may also detect multiple signals reflected off scanning mirror 111.

The coupling discussed herein may include, but is not limited to, electronic connections, coaxial cables, copper wire, and fiber optics, including the wires that comprise data bus 170. The coupling may also take the form of acoustic or light waves, such as lasers and those generated during radio-wave and infra-red data communications. Coupling may also be accomplished by communicating control information or data through one or more networks to other data devices. Mechanical or electro-mechanical coupling as used herein may include, but is not limited to, the use of physical components such as motors, gear coupling, use of universal joints, or any other mechanical or electro-mechanical device usable to couple items together.

Each of the logical or functional modules described above may comprise multiple modules. The modules may be implemented individually or their functions may be combined with the functions of other modules. Further, each of the modules may be implemented on individual components, or the modules may be implemented as a combination of components.

The logical or functional modules described above may be performed on one or more electronic devices. For example, a personal computer may implement functional modules such as (“IO”) module 102, central processing unit (CPU) 103, direct memory access (DMA) control module 105, memory 104, and screening module 106. The remaining functional modules may be implemented on one or more electronic devices, such as a printing device.

CPU 103, screening module 106, and PWM logic module 107 may each be implemented by a field-programmable gate array (FPGA), an application-specific integrated circuit (ASIC), a complex programmable logic device (CPLD), a printed circuit board (PCB), a combination of programmable logic components and programmable interconnects, single CPU chip, a CPU chip combined on a motherboard, a general purpose computer, or any other combination of devices or modules capable of performing the tasks of modules 103,106 or 107. In some embodiments, memory 104 may comprise a random access memory (RAM), a read only memory (ROM), a programmable read-only memory (PROM), a field programmable read-only memory (FPROM), or other dynamic storage device, coupled to data bus 170 for storing information and instructions to be executed by image electronics subsystem 160.

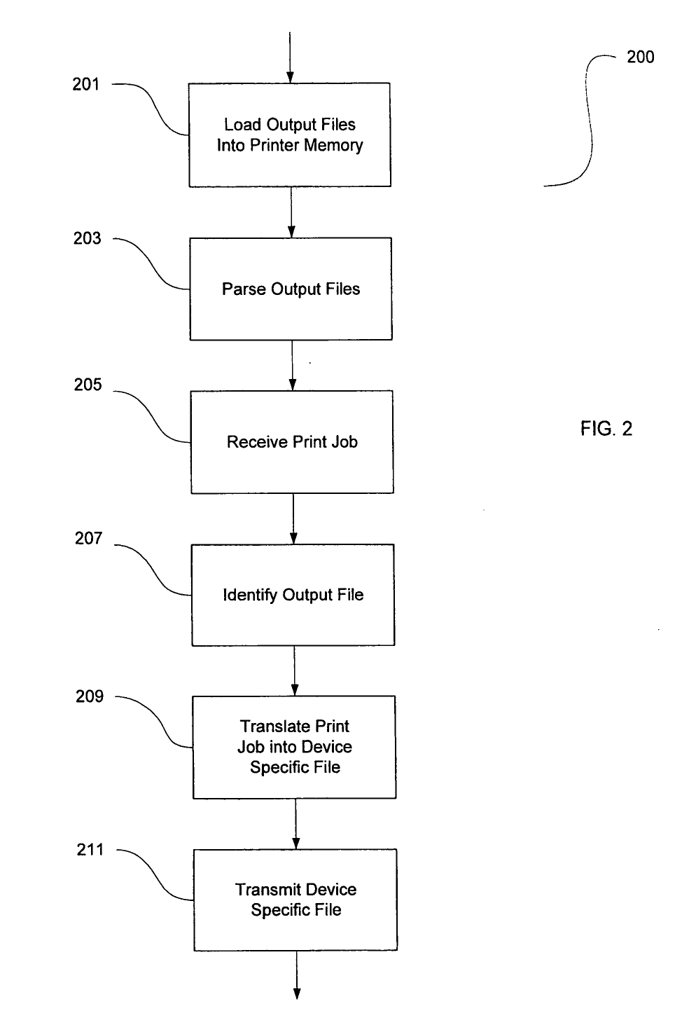

FIG. 2 shows an exemplary process for translating device independent file received by the printer. One or more of steps 201-211 in process 200 may be performed by various modules in printer 100. For example, printer 100 may have a color management system to perform one or more steps in process 200. For example, the color management system of printer 100 may be loaded into memory 104 and initialized at the time that printer 100 is booted up. Routines within the color management system may be executed by CPU 103. Further, the color management system may be implemented using image data I/O module 102 and/or DMA control module 105.

In some embodiments, output files 156 may be loaded into printer memory 104, in step 201. Output files 156 may be used to translate print job 152 containing device independent data into device specific data file 154 that the printer may use to produce an output document. Print job 152 may be received from computer 101 coupled to printer 100. Print job 152 may contain device-independent colors if print job 152 uses a device-independent color model such as CIELAB. Applications that allow you to save images in the CIELAB model may include Adobe Photoshop and Heidelberg's LinoColor. The International Commission on Illumination (Commission Internationale d'Eclairage or CIE) developed CIELAB as a color model to represent each color visible to the human eye and to standardize a method for determining a color difference. The three coordinates of CIELAB represent the lightness (L) of the color, the color's position between red/magenta and green (A), and the color's position yellow and blue (B).

In some embodiments, however, print job 152 may contain device dependent color representations or models such as RGB data from a digital camera or a color scanner. Because device-dependent values generated by computer 101 may not produce the correct output when used in printer 100, print job 152 containing device-dependent color values may have an embedded input profile for converting the device-dependent color values in computer 101 to device-independent colors values for use in printer 100. The embedded input profile may be a lookup table for converting the device-dependent color values to device-independent values. The color management system may then convert the device-independent color values to device-dependent values used by printer 100 for producing a printed output. If print job 152 containing device-dependent color values does not contain an embedded input profile, then an input profile may be assigned to print job 152 to allow the color management system to convert the color values in print job 152 to device-specific values used by printer 100.

Output file 156 may aid in the transformation of print job 152 into data file 154 having a format specific to printer 100 that may be used to produce an output document. This transformation may be accomplished by a color management system which may use ICC (International Color Consortium) profiles. ICC profiles may include look-up tables that can be used to translate the color of a pixel from one color model to another color model. An ICC profile may be a lookup table for translating the color of a pixel from one color model to one or more color models. For example, ICC profiles may allow the color management system to translate the color values from a device independent file such as CIELAB to a device dependent file such as RGB or CMYK. The ICC files may also allow the color management system to translate between values in different device specific files such as RGB and CMYK by using a common colorspace such as CIELAB.

In some embodiments, the output files may be stored as files in a memory device, such as XML files 150. The memory device may be internal or external to printer 100. For example, computer 101 may store XML files 150 in a computer memory internal to computer 101 or in a memory device that is external to computer 101, such as a USB device, a flash drive, and/or an external hard drive. When printer 100 is booted up, computer 101 may transmit XML files 150 to printer 100 using image data I/O module 102 via connection 120. Printer 100 may parse and load XML files 150 into memory 104 as output files 156. In some embodiments, printer 100 may store output files 156 in a memory device separate from memory 104. For example, in situations where memory 104 may be volatile memory that loses data when printer 100 is powered off, printer 100 may use non-volatile memory to store output files 156. In some embodiments, XML files 150 may only be loaded into memory 104 when printer 100 is booted up.

In some embodiments, XML files 150 may be kept in a file format that allows the output files to be modified. For example, when XML files 150 are stored on computer 101, the files 150 may be stored as XML files, which may be transmitted to printer 100 when it is booted up. The XML format may be used because it provides an easily accessible, wide spread programming language that may be used to change the parameters in XML files 150. Further, changing the parameters of XML files 150 may change corresponding parameters in output files 156. For example, a new output file may be created for certain color model and paper type combinations. To associate the new output file with the correct color model and paper type combination may require that the user open XML file 150 using a standard text editor in computer 101 and change the file name of the ICC file associated with that color model and paper type combination. Accordingly, the user may not need to use firmware to update the ICC file.

In step 203, XML files 150 may be parsed using a decision data structure. The decision data structure may parse XML file 150 based on a set of one or more parameters. The decision data structure may be a jump table, a linked list, a table, or any combination of these three programming constructs. In some embodiments, files 150 may be parsed to create linked list 300 of printer and/or print type parameters. Linked list 300 may be stored in memory 104 and serve as a decision data structure used to identify the desired device specific file 154.

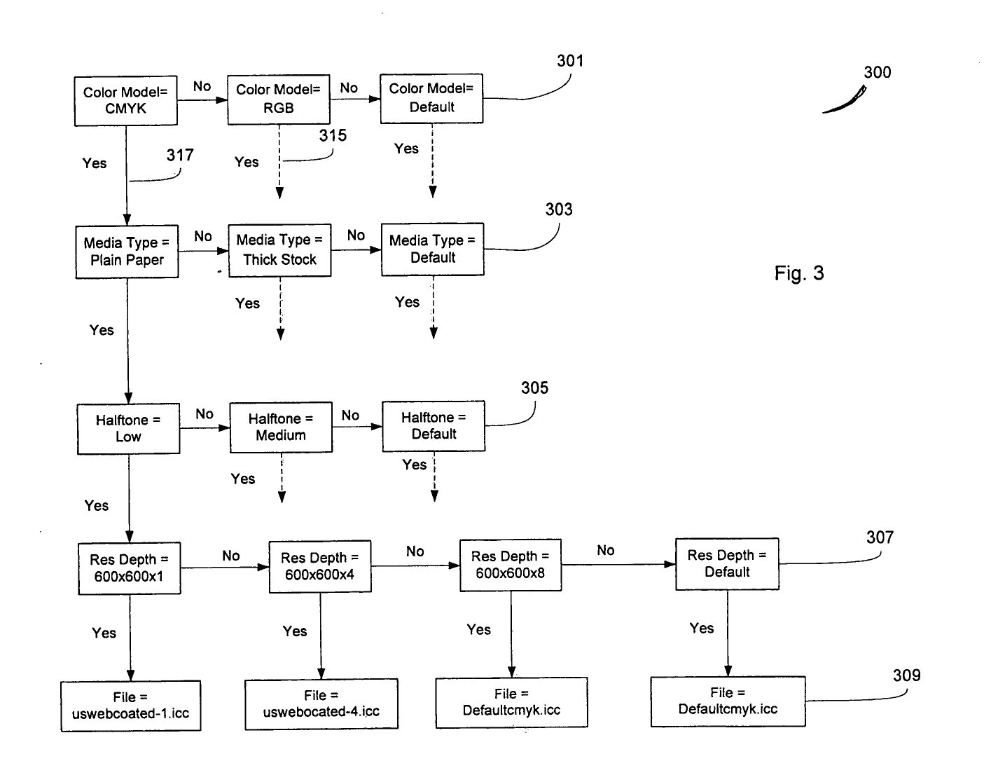

FIG. 3, shows exemplary linked list 300 that may result from parsing the output files. The structure shown is exemplary and for descriptive purposes only and other implementations are possible. As shown in FIG. 3, exemplary, row 301 may contain information about color models that may be used by printer 100, while row 303 may contain information about the type of media used by printer 100. Further, row 305 may contain information about the half-tone type used by printer 100, row 307 may contain information about the resolution depth desired for the output document, while row 309 may contain information about the ICC file that may be used to print a document.

Although linked list 300 only shows a portion of the linked list, one skilled in the art will understand that the dashed lines may go to portions of the linked list that are similar to the portion of the linked list displayed in FIG. 3. In some embodiments, each layer of linked list 300 starting from the appropriate head may correspond to attributes related to similar device or print parameters. For example, for the RGB color model head, dashed line 315 descend to a layer of the linked list for choosing an ICC file given a desired output media, half-tone, and resolution depth. Similarly, for a CMYK color model head, the portion of the linked list connected by line 317 may include a corresponding ICC file layer for choosing an ICC file given desired output media, half-tone, and resolution depth.

As shown in linked list 300, the parsing in step 203 may construct a data structure to determine which output file 156 to use to translate print job 152. The data structure may consist of a multiple layer linked list, such as linked list 300, where each of the layers may correspond to a different device or print parameter that can be used to identify the desired output file. The color management system may be used to construct linked list 300.

The color management system may begin constructing linked list 300 by creating a portion of linked list 300 to distinguish between the different types of color models that may be used by printer 100, as shown by row 301. As shown in FIG. 3, the different types of color models may include a CMYK color model, an RGB color model, and a default color model. The output files may then be parsed by the media type to be used for the output document, as shown in row 303 of linked list 300. For example, the printer may have a plain paper media and/or thick stock media for producing an output document. After choosing the media type, the color management system may then parse the output files to take into account the type of half-tone to use for a printed document, as shown in row 305 of linked list 300. For example, the half-tone type may be low,-medium, or high. In some embodiments, a default half-tone setting may exist. Finally, the output may be parsed based on the resolution of the printed document as shown in row 307 of linked list 300. In some embodiments, the color management system may use the four variables described to identify the desired output ICC file, as shown in row 309.

One skilled in the art will recognize that linked list 300 may be used to determine the correct ICC output file to be used for any combination of color model, output media, half-tone type, and output resolution. Further, output files may be parsed using other data structures. For example, a table may be used to parse the output files. The use of a table or a linked list may be a design decision that might be influenced by the number of variables, memory available, and other factors to be used for determining the correct output file.

At step 205, printer 100 may receive a print job from computer 101. The device independent file may be transmitted by computer 101 for printing an output document. For example, the device independent file may be an RGB file created by a program on computer 101. Image data I/O module 102 may receive the device independent file from computer 101.

At step 207, the color management system may further facilitate the translation of the print job by identifying an output file from output files 156 for translating print job 152 into device specific file 154. The computer management system may use linked list 300 to identify the desired output file. For example, the color management system may first determine the color model used by print job 152 input into printer 100. For example, the color management system may use information available in row 301 to determine if the color model is CMYK, RGB, or a default color model. When print job 152 is a device dependent file, the color management system may still choose the correct output file from output files 156 as determined by linked list 300 and generate device specific file 154.

If the color model is CMYK, the color management system then may use information available in row 303 of linked list 300 to identify the output media. For example, the media type might be plain paper or thick stock. Once the color management system determines the type of media, it may use the portion of linked list 300 in row 305 to determine the type of halftone to be used for a document. The print tone may be low, medium, high, or default in some embodiments of printer 100. As shown in FIG. 3, when the print tone in row 305 is low, the color management system may use row 307 to determine the resolution depth of the output document. The color management system may use the combination of color model, output media, half-tone, and resolution depth to determine the correct ICC file in row 309. For example, when the color model is CMYK, the output media is plain paper, the half-tone is low, and the resolution depth is 600×600×1, the correct ICC output file may be “uswebcoated-1.icc.”

In step 209, the color management system may use the identified output file to translate the print job into a device specific data file to be used by printer 100 to print a document. In some embodiments, the output file may be an ICC data file containing ICC profile information. The translated device specific data file may contain specific color values that represent the actual color that may be produced on the printed output document.

Next, in step 211, the color management system may transmit the device specific data file to memory 104 in printer 100. In some embodiments of printer 100, the device specific data file may be used to create pixel data for pixels in an output document. For example, the pixel data may include the color values and pixel widths for each pixel in the output document. Further, CPU 103 may control when the pixel data is transmitted from memory 104 to screening module 106. For example, CPU 103 may control the data transmission so that memory 104 holds one or more pages of pixel data before transmitting the pixel data to screening module 106. The pixel data may then be used to print the output document with the desired color values.

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims. As such, the invention is limited only by the following claims.

What is claimed is:

1. An image forming apparatus, comprising:
a first memory component located in a printing device, wherein the first memory component receives one or more data files and a print job file from one or more external memory devices;
a DMA control module, wherein the DMA control module parses the one or more input files to create a decision data structure;
a color management system stored in the first memory component, wherein a CPU accesses the color management system to:
identify one of a plurality of output files based on information in the print job file using the decision data structure; and
translate the print job file into a printer specific data file based on information contained in one of the plurality of output files; and
one or more print heads operable to print an output document as a function of the printer specific data file.

2. The image forming apparatus of claim 1 wherein:
the decision data structure comprises a linked list.

3. The image forming apparatus of claim 1, wherein the decision data structure includes a set of parameters for identifying the one of the plurality of output files.

4. The image forming apparatus of claim 3, wherein the set of parameters consists of a color model, a type of media, a halftone setting, and a resolution depth setting.

5. The image forming apparatus of claim 1, wherein the plurality of output files is stored in a second memory component, the color management system being operable to load the plurality of output files into the first memory component when the printing device is booted up.

6. The image forming apparatus of claim 5, wherein the second memory component stores the plurality of output files in one or more XML format files.

7. The image forming apparatus of claim 6, wherein the color management system further parses the one or more XML format files when loading the one or more XML format files into the first memory component.

8. A method for forming an image, the method comprising:
receiving at a first memory component in a printing device one or more data files and a print job file from one or more external memory device;
parsing the one or more input files at a DMA control module to create a decision data structure; and
accessing a color management system stored in the first memory component, wherein the color management system:
identifies one of a plurality of output files based on information in the print job file using the decision data structure; and
translates the print job file into a printer specific data file based on information contained in one of the plurality of output files; and
transmits the printer specific data file to one or more print heads that are operable to print an output document as a function of the printer specific data file.

9. The method of claim 8 wherein:
parsing the one or more input files to create a decision data structure further includes creating a linked list.

10. The method of claim 8, wherein the decision data structure includes a set of parameters for identifying the one of the plurality of output files.

11. The method of claim 10, wherein the set of parameters consists of a color model, a type of media, a halftone setting, and a resolution depth setting.

12. The method of claim 8, further including loading the plurality of output files from a second memory component into the first memory component when the printing device is booted up.

13. The method of claim 12, further including storing the plurality of output files in the second memory component as one or more XML format files.

14. The method of claim 13, wherein the color management system further parses the one or more XML formatting files when loading the one or more XML format files into the first memory component.

15. An image forming system, comprising:
a first memory component located in a printing device, wherein the first memory component receives one or more data files and a print job file from one or more external memory device;
a DMA control module, wherein the DMA control module parses the one or more input files to create a decision data structure;
a color management system stored in the first memory component, wherein a CPU accesses the color management system to:
identify one of a plurality of output files based on information in the print job file using the decision data structure; and
translate the print job file into a printer specific data file based on information contained in one of the plurality of output files; and
one or more print heads operable to print an output document as a function of the printer specific data file.

16. The image forming system of claim 15 wherein:
the first memory component, the DMA control module, the color management system and the one or more print heads are located on at least two separate electronic devices.

17. The image forming system of claim 15, the decision data structure including a set of parameters for identifying the one of the plurality of output files, wherein the set of parameters consists of a color model, a type of media, a halftone setting, and a resolution depth setting.

18. The image forming apparatus of claim 15, wherein the plurality of output files is stored in a second memory component, the color management system being operable to load the plurality of output files into the first memory component when the printing device is booted up.

19. The image forming system of claim 5, wherein the second memory component stores the plurality of output files in one or more XML format files.

20. The image forming system of claim 6, wherein the color management system further parses the one or more XML format files when loading the one or more XML format files into the first memory component.
